(19) United States
(12) Patent Application Publication
(10) Pub. No.: US 2017/0255291 A1
(43) Pub. Date: Sep. 7, 2017

(54) Portable Interactive Projection Display Apparatus

(71) Applicants: Matthew Calvin Hinson, Carrollton, TX (US); Kraig P. Kooiman, Winters, CA (US)

(72) Inventors: Matthew Calvin Hinson, Carrollton, TX (US); Kraig P. Kooiman, Winters, CA (US)

(21) Appl. No.: 15/058,168

(22) Filed: Mar. 2, 2016

(51) Int. Cl. G06F 3/042

(52) U.S. Cl. CPC G06F 3/042

(57) ABSTRACT

Provided is an apparatus for holding a relatively small video or image projector and an integrated projector screen and touch enabled projection surface in place and in proper alignment in order to achieve a portable, interactive, touch-enabled display solution which may sit on a table top, a desk top, or any substantially flat surface, and which may produce a relatively large sized display for the purpose of viewing and directly manipulating necessarily large images such as engineering and construction drawings and 3D models, graphic design and advertising art, and complex charts and schedules.

### CROSS-REFERENCE TO RELATED APPLICATIONS

This application claims the benefit of U.S. Provisional Application No. 62/126,825, filed Mar. 2, 2015, entitled TABLE TOP INTERACTIVE PROJECTION DISPLAY SYSTEM which is incorporated by reference herein in its entirety.

### BACKGROUND

Drawings and 3-D models used in the architecture, engineering, construction, oil & gas, graphic design, and other industries are relatively large. Such drawings and documents must be manipulated and annotated electronically, which poses a challenge when working with said drawings on small electronic displays and on paper. Accordingly, improvements are needed.

### BRIEF SUMMARY OF THE INVENTION

The present disclosure provides for a novel apparatus for holding a relatively small video or image projector and an integrated projector screen and touch enabled projection surface in place and in proper alignment in order to achieve a portable, interactive, touch-enabled display solution which may sit on a table top, a desk top, or any substantially flat surface, and which may produce a relatively large sized display for the purpose of viewing and directly manipulating necessarily large images such as engineering and construction drawings and 3D models, graphic design and advertising art, and complex charts and schedules.

### BRIEF DESCRIPTION OF THE DRAWINGS

FIGS. 1A-1B illustrate orthogonal views of one embodiment of an interactive display apparatus;

FIG. 2 illustrates an orthogonal view of one embodiment of the apparatus of FIG. 1A with an example of content that may be displayed;

FIG. 3 illustrates an orthogonal view of one embodiment of the apparatus of FIG. 1A with the projector rotated approximately ninety degrees;

FIG. 4 illustrates an embodiment of the apparatus of FIG. 1A with the projector rotated approximately ninety degrees, projecting an image onto a nearby wall;

FIG. 5 illustrates an orthogonal view of one embodiment of the apparatus of FIG. 1A in a folded position;

FIG. 6 illustrates one embodiment of the apparatus of FIG. 1A in which the displayed content can be provided by means of a wired connection to a desktop or laptop computer, a wireless connection to a laptop computer, a smart phone or a tablet computer, or by means of computer components mounted inside the apparatus itself;

FIG. 7A-7E illustrate front side, left side, right side, back side, and top side views, respectively, of one embodiment of the apparatus of FIG. 1A;

FIG. 8 illustrates an exploded view of one embodiment of the apparatus of FIG. 1A;

FIGS. 9A-9B illustrate cutaway side views of two different embodiments of the apparatus of FIG. 7E taken along lines A-A.

### DETAILED DESCRIPTION

Referring now to the drawings, wherein like reference numbers are used herein to designate like elements throughout, the various views and embodiments of a table top interactive projection display system apparatus are illustrated and described, and other possible embodiments are described. The figures are not necessarily drawn to scale, and in some instances the drawings have been exaggerated and/or simplified in places for illustrative purposes only. One of ordinary skill in the art will appreciate the many possible applications and variations based on the following examples of possible embodiments.

Individuals working in the architectural, engineering, construction, oil & gas, graphic design, and other similar industries typically use large drawings that have dimensions that conform to a particular industry standard. For example, the drawing dimensions may be defined by a known standard detailed by an organization such as the International Standards Organization (ISO) or the American National Standards Institute (ANSI). Alternatively, the drawings may be a custom size defined by an in-house or other non-conventional specification. Regardless of the exact dimensions used, such drawings have conventionally been printed on large sheets of paper that are rolled up for transportation and storage. The drawings, which are also referred to herein as blueprints, often provide highly detailed specifications for buildings, engineering projects, and other projects that require accurate plans. The large size of the drawings may aid a user in clearly discerning specific details and so reducing the size increases the possibility that numbers, letters, lines, and other features will be overlooked or misread.

However, not only do conventional paper drawings represent a cumbersome approach due to the nature of large rolls of paper (e.g., difficult to manage and easily torn), but paper drawings are difficult to update, and care must be taken not to use outdated drawings. While drawings may be available in digital format, AEC drawings are generally far too large to be fully viewable at a 1:1 scale on a portable device's or standard computers' digital displays. In other words, a user must scroll around the digital display to see the entire drawing at a 1:1 scale or zoom out to see the full drawing. Scrolling around makes it difficult to get an overall view of the drawing, while zooming out to get an overall view reduces the amount of detail that is easily visible and increases the possibility that errors in reading the drawing will occur.

Larger digital screens may be used, but many users prefer to look at screens that can be laid flat like paper blueprints, rather than screens that are vertical like many larger digital screens. Furthermore, larger digital screens lack ease in portability. Accordingly, while conventional digital devices solve certain problems that occur with paper drawings, they introduce other issues. As such, it is clear that neither paper drawings nor currently available digital solutions are ideal.

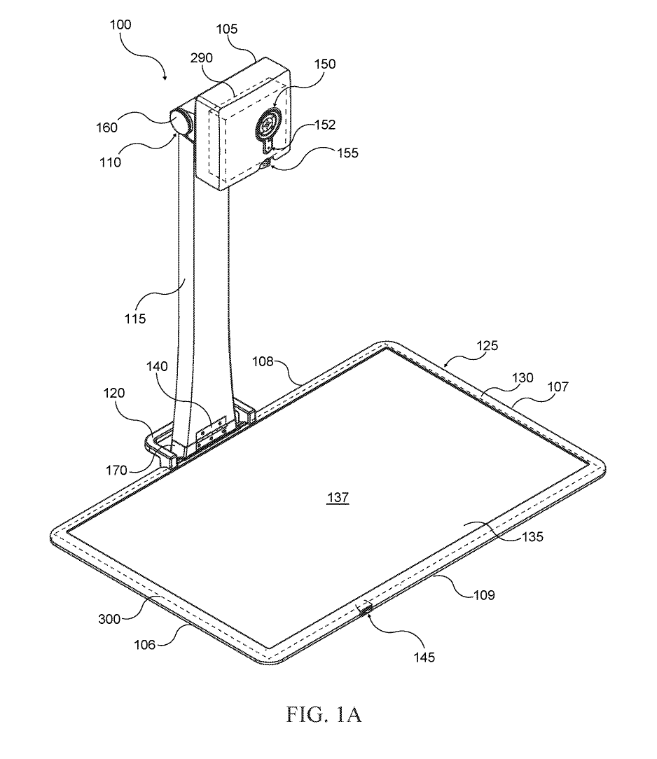

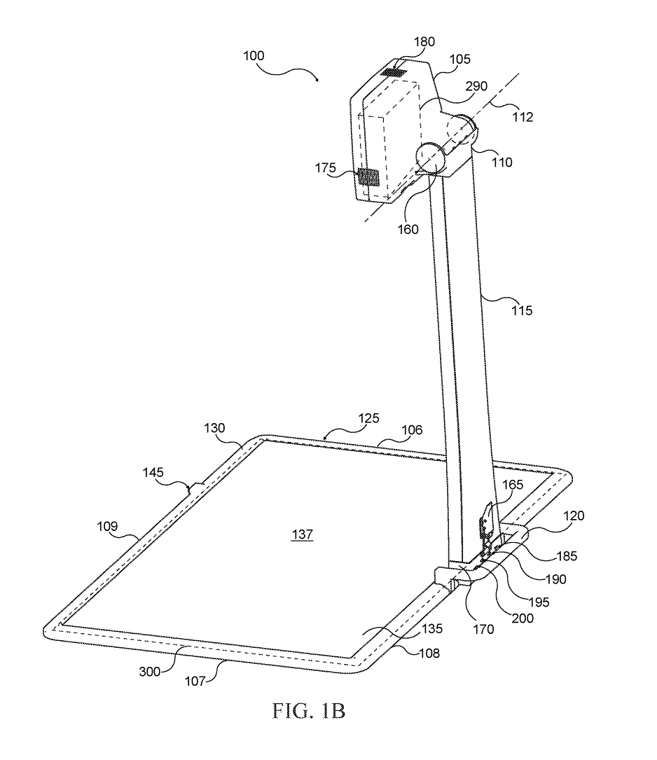

Referring to FIGS. 1A-1B, one embodiment of an interactive display apparatus 100 is illustrated that provides a portable large scale drawing and 3-D model solution. In the present example, the apparatus 100 includes a housing 105 that contains components that make up a projector 290. The housing 105 is affixed to a pivot mount 110 which is affixed to the top of a column 115 which is affixed to a column base 170 via a hinge 140 and a latch 165. It is understood that the hinge 140 may be a modular unit mounted onto the column 115 and the column base 170, or it could comprise hinge loops molded directly into the column 115 and the column base 170, with a pin inserted through the hinge loops to for an operable hinge assembly. The column base 170 is attached to a screen assembly 125 which comprises a touch-enabled projection screen 135 sandwiched between a perimeter frame 130 and a base 300. In the present example, the projector housing 105 is rectangular in shape and the column 115 is a rectangular tube with a cross-section which mates with the cross-sections of the pivot mount 110 and the column base 170, while the screen assembly 125 is rectangular in shape. However, it is understood that the projector housing 105, the column 115, and the screen assembly 125 may take on many different overall all shapes and may have many different cross-sectional shapes. For example, ovals, squares, rectangles, hexagons, octagons, and any other symmetrical and non-symmetrical shapes may be used for the projector housing 105, the pivot mount 110, the column 115, the column base 170, and the screen assembly 125. Furthermore, portions of each of the aforementioned components may vary in width, thickness, and/or length and may be made of any suitable material or combination of materials, including metals, plastics, and glass.

The touch-enabled projection screen 135 may be formed using a technology such as projected capacitive touch, infrared, surface acoustic wave, and/or similar technologies that can produce a touch enabled surface. This touch enabled surface may be overlaid with a light-colored or white opaque surface or may be clear itself, overlaid on a light-colored or opaque surface, such that an image may be projected onto it and be visible by a user of the apparatus 100.

In the present example, the screen assembly 125 is substantially rectangular in shape with a left edge 106, a right edge 107, a rear edge 108, a front edge 109, and a display surface 137. It is understood that terms such as “left,” “right,” “top,” and “bottom” are from the perspective of FIGS. 1A-1B and are for purposes of description only.

In the present example of one embodiment of an interactive projection display apparatus 100 a carry handle 120 is mounted at the rear side 108 of the screen assembly 125 near the column base 170. It is understood that the location of the carry handle 120 could vary and may be located at any location along the rear side 108, front side 109, left side 106, or right side 107.

The projector housing 105 may also include one or more control features 150, communication ports 152 and/or other components that may be used to interact with and/or control the projector 290. The control features 150, communication ports 152, and/or other components may be mounted on the face and/or on one or more sides of the housing 105. Connections for the control features 150 and/or communication ports 152 may be coupled to electronic components within the housing 105 via wired connections or the control features 150 and/or communication ports 152 may be wirelessly connected to the electronic components within the housing 105.

In some embodiments, the housing 105 may include one or more vent openings 175, 180 (e.g., slits, slots, and/or holes) that provide air intake and/or exhaust ports for cooling purposes. It is understood that these vent openings 175, 180 may be located in many different locations on the housing 105, depending on the various orientations and venting needs of the internal projection components 290, and more or fewer vent openings 175, 180 in various configurations may be used.

In this particular embodiment, the projector 290 and housing 105 are mounted vertically above the projection display surface 137 toward the rear side 108 of the screen assembly 125 with the projector lens pointed toward the projection display surface 137 in such a manner that it projects an image onto the projection display surface 137, providing a usable interactive display.

It is understood that the projector 290 and housing 105 may be mounted at various heights and at many different locations above the projection display surface 137.

In this particular embodiment, the housing 105 is connected to a pivot mount 110 which is located at the top of the column 115. This pivoting connection allows the housing 105 to rotate about the pivot connection axis 112, which allows the user of the interactive projection display apparatus 100 to project a useful image onto a nearby adjacent wall or other projection screen mounted on a wall, hanging from a ceiling, or mounted on a stand. On either end of the pivot mount 110 axis 112 end caps 160 are mounted for aesthetic purposes. In order to lock the housing 105 into a desired position about the pivot axis, detents along the inner walls of the pivot mount 110 may be provided at various points that cause the housing 105 to “click” into position at various rotation points about the pivot axis 112. In other embodiments of the display apparatus 100 the axial position may be set by means of an axial screw clamp, which runs through the pivot mount along the pivot axis and applies pressure axially inward on the connection points of the housing 105 and the pivot mount 110, creating friction, which holds the housing in place at a given position about the axis 112.

In this particular embodiment shown in FIGS. 1A-1B, connectors for DC-in power 185 to the projector 290 a USB connection 190 routed to the projector 290 a USB connection 195 to the touch screen 135, and an HDMI connection 200 to the projector 290 are provided at the back side of the column base 170, in order to provide a means to an operable interactive projection display to be connected to an external computer or smart mobile device. It is understood that many other types of connectors and means of connection may be used in other embodiments of the apparatus 100. It is understood that the locations of the connectors may be in multiple different locations on the left side 106, right side 107, rear side 108, or front side 109 of the screen assembly 125, or on any side of the column base 170, the column 115, the pivot mount 110, or the projector housing 105.

In this particular embodiment, a touch sensor on/off switch 145 is mounted on the front side 109 of the screen assembly 125, near the left side 106 of the screen assembly 125. It is understood that the touch sensor on/off switch 145 may be located in many different locations around the perimeter of the screen assembly 125, on the column base 170, on the column 115, on the pivot mount 110, on the projector housing 105, or the touch sensor may be turned on or off wirelessly or via software. Turning the touch sensor off at times will allow a user to place papers, books, or other objects on the touch surface 137 without causing user interface interference on the connected external computer while the interactive display 100 is still connected but not necessarily in use.

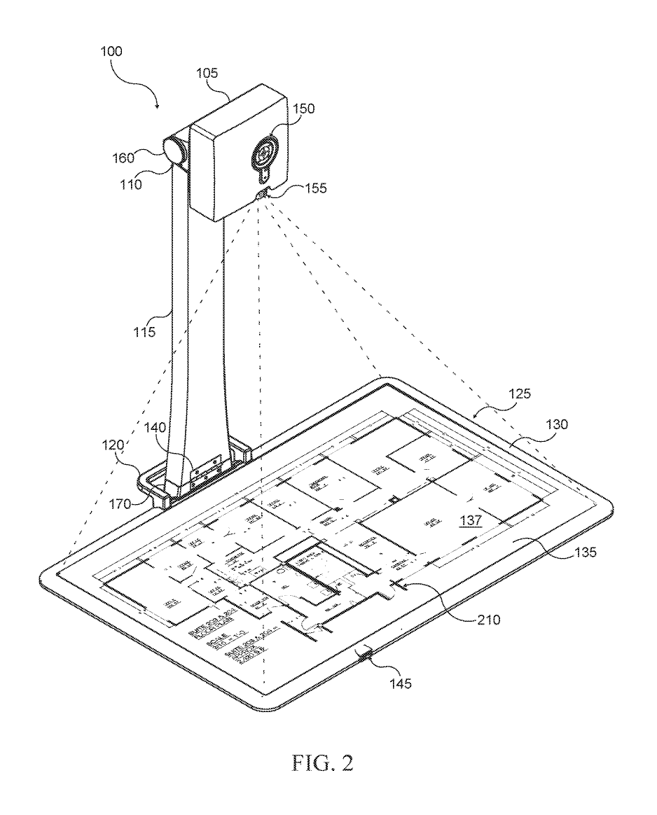

Referring to FIG. 2 one embodiment of the interactive projection display apparatus 100 of FIG. 1A is illustrated with the projector 290 projecting an example blueprint image 210 onto the projection display surface 137. A user may focus and adjust the keystone of the projected image by operating the projector control buttons 150, or by operating buttons on a remote control.

It is understood that the size of the display surface and of the apparatus 100 itself may vary greatly to provide various sized displays based on the needs of the user and of the content to be displayed.

Because the apparatus 100 of FIG. 2 may be used, in some cases, to provide a display that duplicates or exceeds the dimensions of a defined blueprint size, the display may vary in size to match commonly used blueprint dimensions. For example, the display 104 may be designed to provide a full-size (1:1) drawing in the device 100a, a half-size (1:2) drawing in the device 100b, and/or other drawing sizes based on a drawing scale that complies with desired dimensions. In some embodiments, the dimensions may be defined by a known standard detailed by an organization such as ISO or ANSI (e.g., the ANSI/ASME Y14.1 standard). Examples of standardized drawing dimensions are illustrated below in Table 1 (ISO) and Table 2 (ANSI/ASME).

TABLE 1
ISO A DRAWING SIZES (mm)

| | |
|---|---|
| A4 | 210 × 297 |
| A3 | 297 × 420 |
| A2 | 420 × 594 |
| A1 | 594 × 841 |
| A0 | 841 × 1189 |

TABLE 2
ANSI/ASME DRAWING SIZES (inches)

| | |
|---|---|
| A | 8.5 × 11 |
| B | 11 × 17 |
| C | 17 × 22 |
| D | 22 × 34 |
| E | 34 × 44 |
| D1 | 24 × 36 |
| E1 | 30 × 42 |
| E | 36 × 48 |

In some embodiments, the apparatus 100 may be used to provide half-size blueprints in addition to full-size blueprints, thereby enabling a larger apparatus to be more flexible in supported blueprint sizes than a smaller apparatus. In such embodiments, the half-size blueprints may be shown in their correct 1:1 scale or may be scaled to fit the display surface. In some embodiments, a device may be configured to show all smaller drawing sizes. Accordingly, a device with a display 137 having the dimensions needed to show 1:1 scale ANSI E drawings would also be able to show A-D, E1, and D1 drawings.

Similarly, a device with a display surface 137 having the dimensions needed to show 1:1 scale ANSI E drawings would also be able to show A-D, E1, and D1 drawings. Similarly, a device with a display surface 137 having the dimensions needed to show 1:1 scale ISO AO drawings would also be able to show A1-A4 drawings.

It is understood that the benefits of using an embodiment of an interactive projection display apparatus 100 extend far beyond the viewing and manipulation of large scale two-dimensional drawings, but can be greatly beneficial in other disciplines including but not limited to the viewing and manipulation of three-dimensional models in building, civil, mechanical, electrical, and product design, as well as the viewing and manipulation of graphic design projects, military or operational diagrams, or in various educational applications in which a large, portable table-top display would be of benefit.

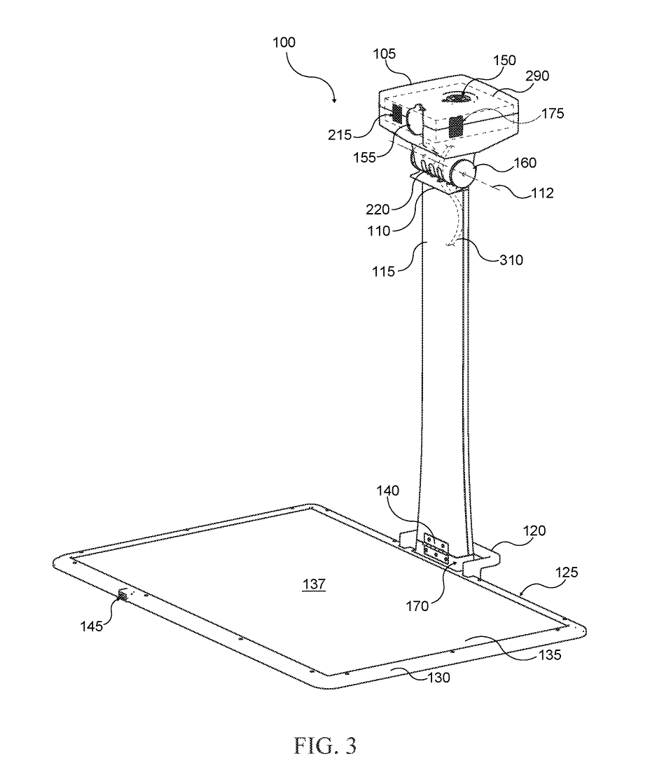

Referring to FIG. 3, one embodiment of the apparatus 100 of FIG. IA is illustrated with the projector housing 105 rotated approximately 90 degrees about the pivot axis 112 orienting the projector lens 155 in such a manner that it can project an image onto a plane perpendicular to or nearly perpendicular to the projection display surface 137, such as a nearby wall or projection screen.

Illustrated in this particular embodiment of the apparatus 100, on the rear and underside of the projection housing 105, are slots 220 cut out around the radius of the back side of the housing 105, where the housing 105 is attached to the pivot mount 110. These slots 220 follow the contour of the rear part of the housing 105 which forms an arc about the pivot axis 112. These slots 220 allow various wires and/or cables 310 to be routed through the column 115 and the pivot mount 110, and into the projector housing 105, allowing connections to the projector components 290.

In this view of one embodiment of the apparatus 100, two vents 175, 215 are illustrated on the projector housing 105 for the aforementioned purposes of heat removal and ventilation. Again, it is understood that these vent openings 175, 215 may be located in many different locations on the housing 105, depending on the various orientations and venting needs of the internal projection components 290 and more or fewer vent openings 175, 215 in various configurations may be used.

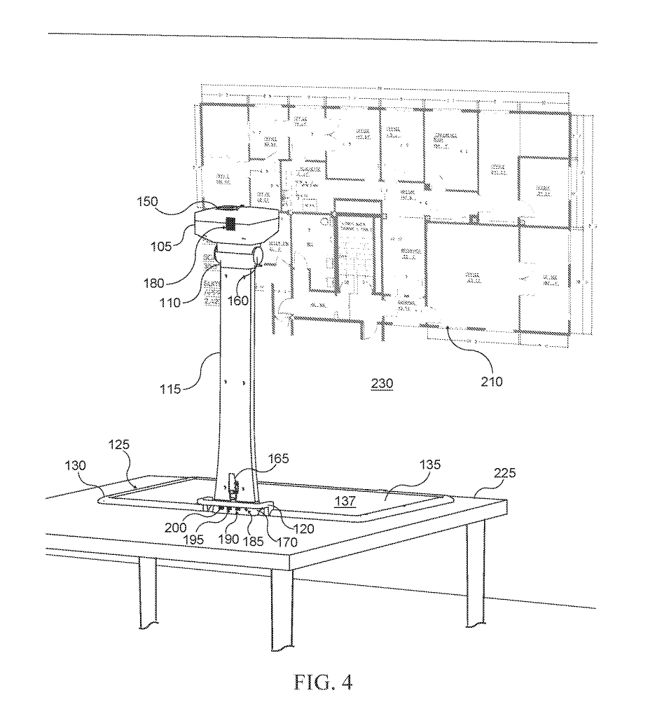

Referring to FIG. 4, one embodiment of the apparatus 100 of FIG. 1A is illustrated. In the present embodiment, the apparatus 100 is sitting on top of a table 225, but it is understood that the apparatus 100 may also be set on top of a desk, a plan table, or any other relatively flat surface. The projector housing 105 is shown rotated approximately 90 degrees and projecting an image 210 of a construction blueprint onto an adjacent wall 230. This will allow a user to easily transition from viewing an image 210 on the interactive projection display surface 137 to viewing an image 210 on a nearby wall or projection screen in a size equal to or greater than the size of the display surface 137, depending on the distance of the wall 230 from the projector lens 155. It is understood that the orientation of the content projected will be upside down when transitioning from projecting downward onto the projection display surface 137 to a nearby wall 230 or projection screen. The user would simply operate the control features 150 located on the projection housing 105 or on a remote control device in order to digitally flip the image right-side up (a common feature found among existing projectors and projector technology) for proper useful viewing of the image. It is understood that a projected infrared touch sensor technology may be used in order to provide touch interaction with the displayed image 210 on the wall 230.

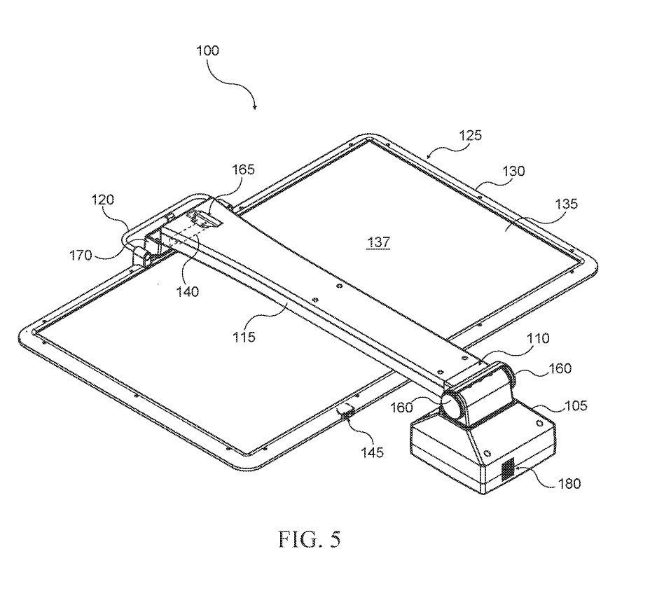

Referring to FIG. 5, one embodiment of the apparatus 100 of FIG. 1A is illustrated. In the present embodiment, the apparatus 100 is in a folded position, allowing the apparatus 100 to easily be stowed away or transported by a user to different locations.

In the present embodiment, the column 115 (along with all components attached to the top of the column 115) may pivot about the hinge 140, which, in conjunction with the latch 165, secures the column 115 to the column base 170. In order for the column 115 to pivot about the hinge 140, the user must first disengage the latch 165. The user may subsequently carry the apparatus 100 by grasping the carry handle 120, lifting the apparatus 100, and transporting it to the desired location.

It is understood that the column 115 may, in different embodiments of the apparatus 100, be folded in many different locations multiple times using similar common hinging techniques to make the apparatus 100 more compact for storage and transport purposes. Furthermore, it is understood that in different embodiments of the assembly 100, the column 115 may have a telescoping function, in which the column 115 tube is cut into sections with progressively smaller cross-sectional dimensions which fit together to form a column assembly which “telescopes” in and out or up and down in order to achieve more compact overall apparatus 100 dimensions for the purpose of storage and transport. It is understood that in different embodiments of the apparatus 100, the entire screen assembly 125 may be made up of flexible materials which allow the screen assembly 125 to be partially or completely rolled up while not in use or in storage or transport. Such rolling action would be made possible through flexible thin film transistor touch surfaces and other flexible electronics and materials. It is understood that in different embodiments of the apparatus 100, the column base 170 may be easily detached and reattached to the screen assembly 125 while not in use or while in storage or transport.

In some embodiments of the apparatus 100, a locking mechanism (not shown) may be used to prevent the column 115 from moving or pivoting during transport. For example, a tab or clip attached to the front of the screen assembly 125 may be placed over the back side of the column to prevent unwanted movement during transport of the apparatus 100.

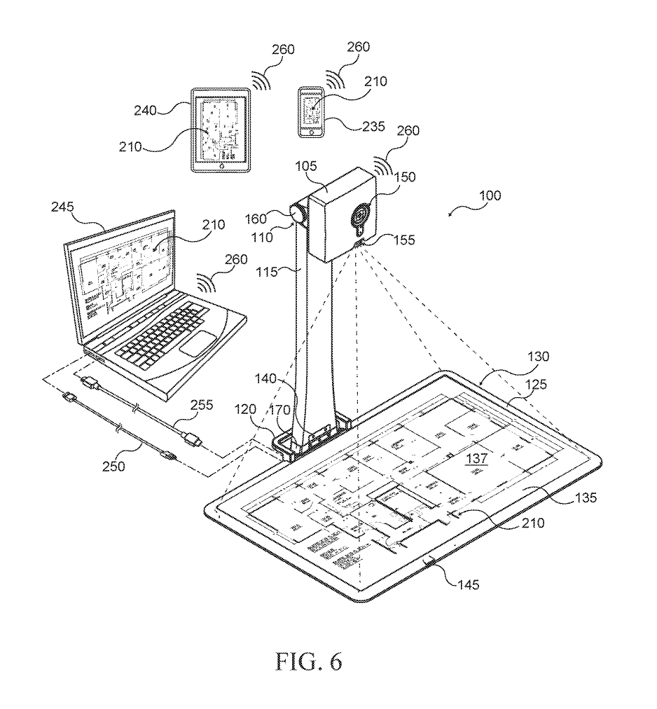

Referring to FIG. 6, one embodiment of the interactive projection display apparatus 100 of FIG. 1A is illustrated with external devices such as portable digital devices 235 and 240 a portable (laptop) computer 245. The apparatus 100 may communicate with these or other external devices wirelessly as indicated by lines 260 and/or via wire 250 and 255. It is understood that these are merely examples and that the apparatus 100 may communicate with many other devices. The apparatus 100 may act as a peripheral interactive display to external devices 235, 240, and 245 and may mirror the image 210 displayed on external devices or may serve as an extension of the external devices' 235, 240, and 245 displays.

In the present example, the apparatus 100 is mirroring an image of a construction blueprint 210, as the image 210 may be seen on the screens of the portable digital devices 235 and 240 the portable (laptop) computer 245, and on the projection display surface 237.

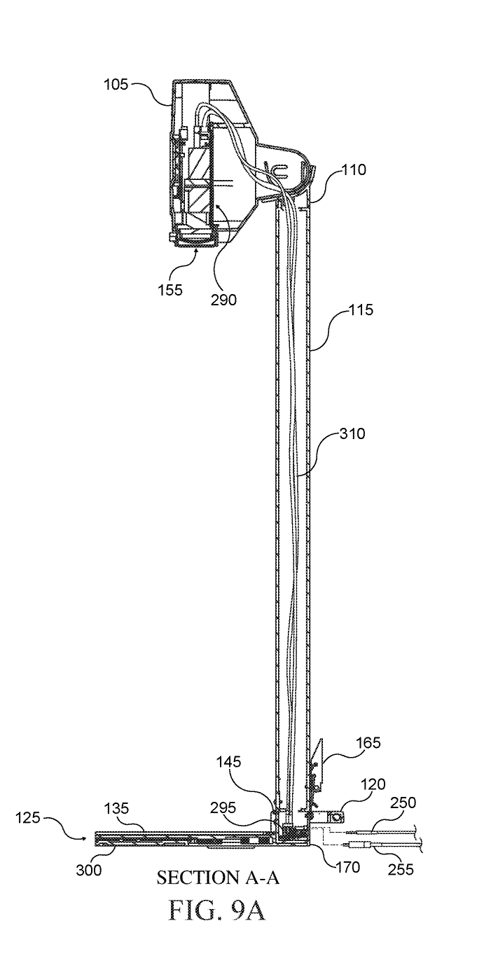

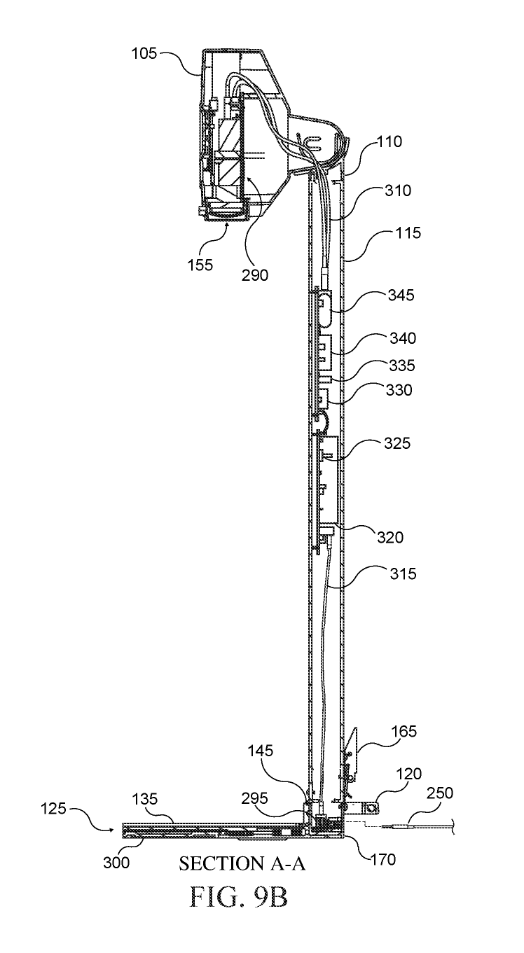

The apparatus 100 may also contain electronic and computer components that allow it to operate independently of external devices, as its own computer device and interactive display, all in one assembly. An illustration of on embodiment of the apparatus 100 containing such electronic and computer components can be found in FIG. 9B.

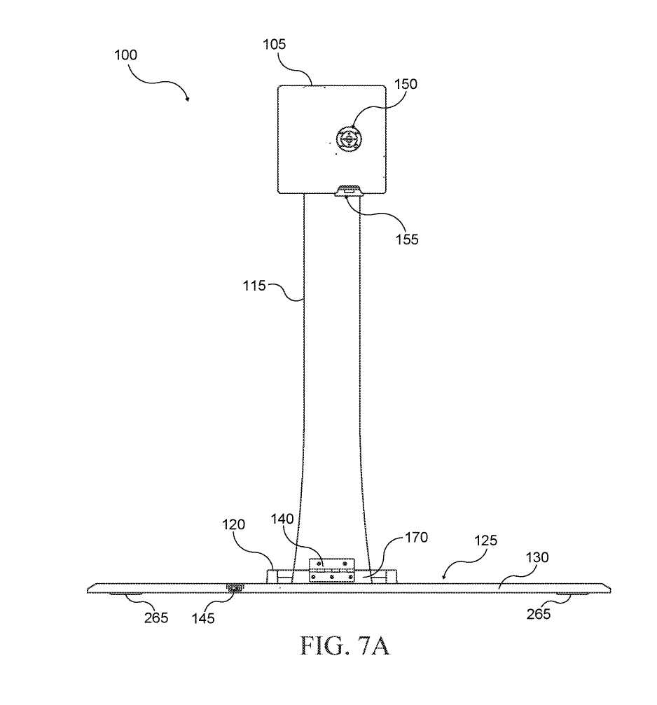

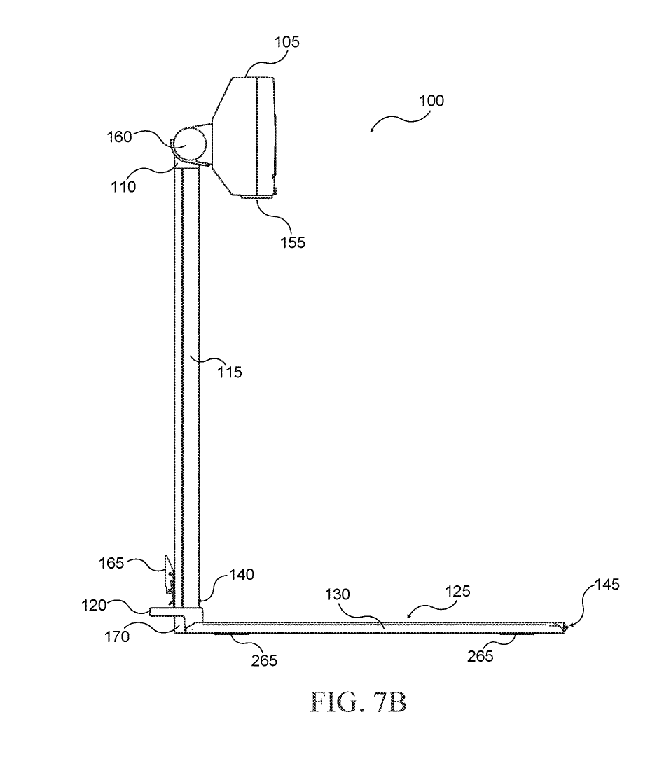

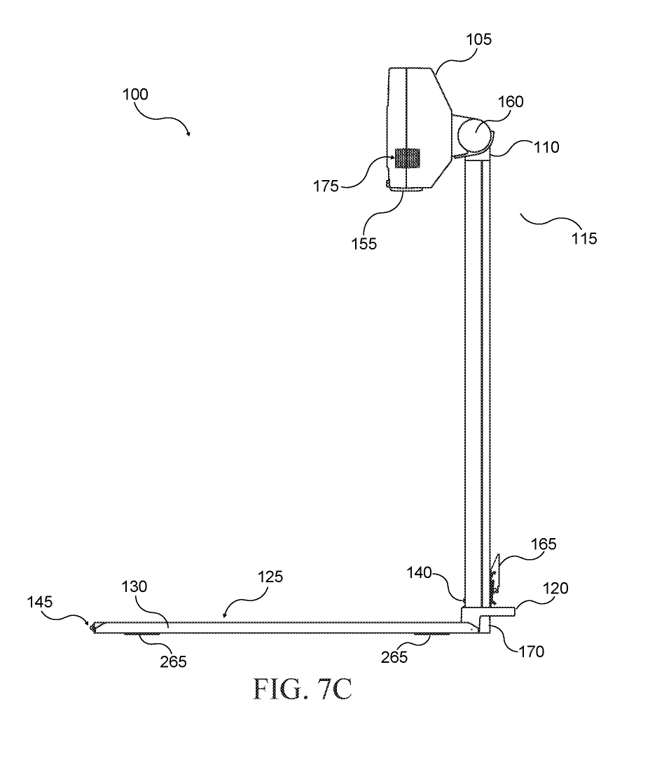

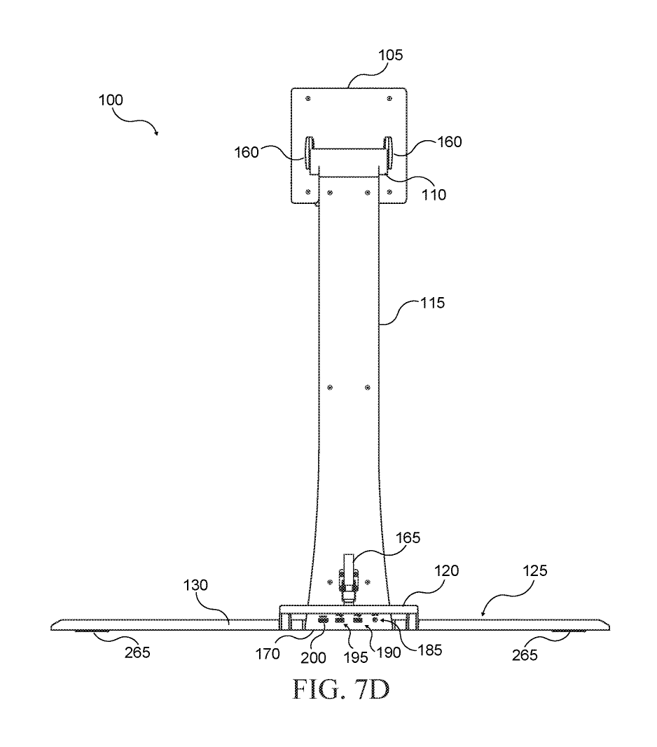

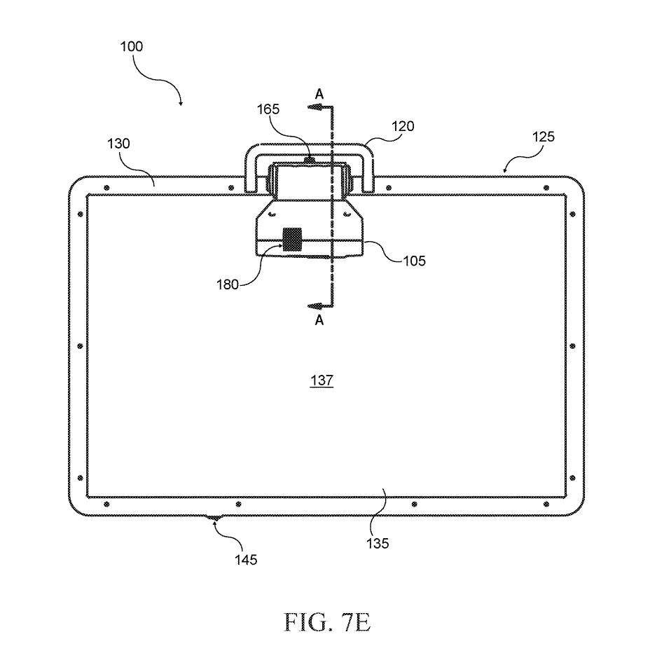

Referring to FIGS. 7A-7E, one embodiment of the apparatus 100 of FIG. 1A is illustrated in a front side view (FIG. 7A), a left side view (FIG. 7B), a right side view (FIG. 7C), a back side view (FIG. 7D), and a top side view (FIG. 7E).

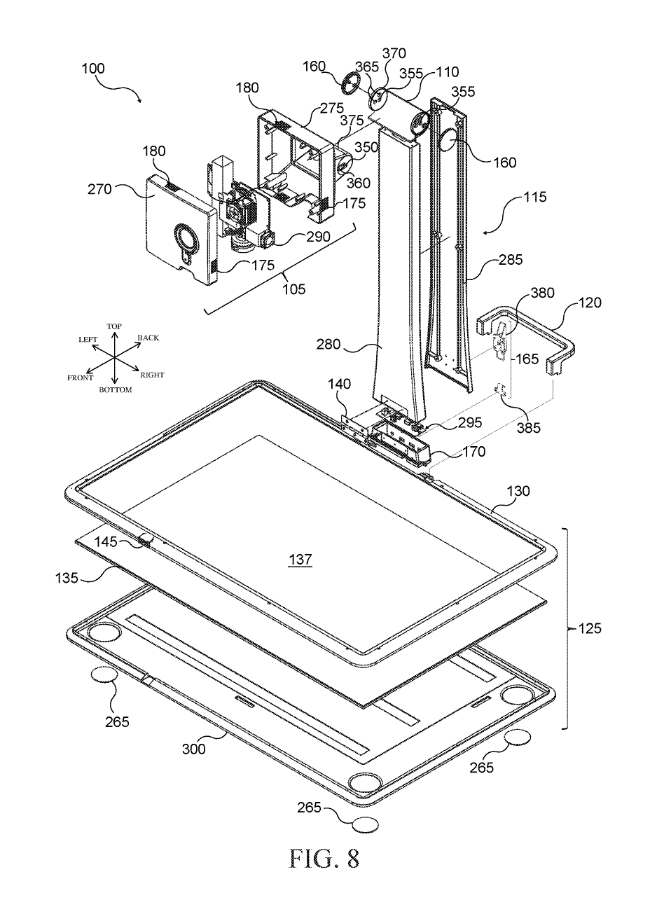

Referring to FIG. 8, one embodiment of the apparatus 100 of FIG. 1A is illustrated that provides an exploded view of a more detailed example of the apparatus 100 of FIGS. 1A and 1B. The apparatus 100 includes a housing 105 that contains projector components 290. The housing 105 is substantially hollow in order to fit the projector components and other electronic components inside, although support structures may be built into the housing 105 for strength and/or to provide attachment points for electronic components and/or mechanical components (e.g., fans, a tension mechanism, and/or a locking mechanism). While the housing 105 is shown with a rectangular cross-section in the present embodiment, it is understood that the cross-sectional configuration may vary greatly. The housing 105 comprises two parts: a front half 270 and a back half 275, which are mated via screws, glue, or another suitable fastening method, to form one part around the projector components 290. A hole is located on the front side of the front half 270 of the housing 105, which allows the projector control buttons to be accessed from outside of the housing 105 by the user. In the present example, the housing 105 may include one or more vent openings 175 and 180 (e.g., slits, slots, and/or holes) that provide air intake and/or exhaust ports for cooling purposes. It is understood that these vent openings 175 and 180 may be located in many different locations on the housing 105, depending on the various orientations and venting needs of the internal projection components 290 and more or fewer vent openings 175 and 180 in various configurations may be used.

In the present example of the apparatus 100, the rear half 275 of the housing 105 has a protrusion with a radiused end 375 which has a short, chamfered pivot stud 350 at the center point of the radius on each side of the rear half 275 of the housing 105. The radiused back side 375 of the rear half 275 of the housing 105 fits into the pivot mount 110 between two circular flanges 370 on the left and right sides of the pivot mount 110. The pivot studs 350 protrude slightly beyond the dimension between the inside surfaces of the circular flanges 370, which flex slightly for assembly, and the pivot stud clicks into place inside the pivot holes 355 at the center of each circular flange 370 on the pivot mount 110, creating a functional pivoting assembly.

On either side of the radiused protrusion 375 on the rear half 375 of the housing 105, next to the pivot stud 350 is a flexible tab with a protruding ball detent 360, which mates with either of the two or more detent holes 365 located on the circular tabs 370 on either side of the pivot mount 110. This creates set resting positions of the housing 105 at various points about the pivot axis. It is understood that many other means of setting resting points about the pivot axis may be achieved. For example, an axial clamp mechanism similar to those commonly found on camera stands and tri-pods may be applied to the pivot mount 110, and in such a case, may be manually tightened or loosened by the user to adjust the angle of the projector housing 105 about the pivot axis.

In the present example, the outside of the circular tabs 370 on the pivot mount 110 tend to leave room for aesthetic improvement. To improve aesthetics, circular end caps 160 are fitted to the outside of the circular tabs and may be attached via press-fit connection and/or a glued connection.

In the present example, the pivot mount 110 is mounted via screws onto the top of the column 115, which comprises a front half 280 and a rear half 285, which may be mated together with screws, glue, or another suitable fastening method to form an elongated rectangular tube. While the column 115 is shown with a rectangular cross-section in the present embodiment, it is understood that the cross-sectional configuration may vary greatly. The column 115 is substantially hollow in order to fit various cables, computer components, and/or other electronic components inside, although support structures may be built into the column 115 for strength and/or to provide attachment points for electronic components and/or mechanical components (e.g., a tension mechanism and/or a locking mechanism).

In the present example, the column 115 is attached to the column base 170 via a hinge assembly 140 and a latch assembly 165. The hinge assembly 140 is attached via screws, glue, welds, and/or any other appropriate fastening method to the outside face of the front side 280 of the column 115 assembly. Although the hinge assembly shown in the present example is a modular assembly that is attached to the column 115 and column base 170 with screws and/or another appropriate fastening method, it is understood that the hinge assembly may be molded integrally into the column 115 and the column base 170 and joined together with an extruded cylinder or pin made of metal, plastic, or another appropriate material.

The latch assembly 165 comprises a top portion 380 attached to the outside face of the rear side 285 of the column 115 assembly and a bottom portion 385 attached to the column base 170. When engaged, the top portion 380 of the latch assembly 165 grasps the bottom portion 385 of the latch assembly 165 in a similar manner to any typical existing latch assembly.

The column base 170 is rectangular in shape with sides to form a hollow box with an open top side. In the present example, the column base 170 may be attached to the base 300 of the screen assembly 125 with screws, glue, welds, or any other appropriate fastening method. There are rectangular and/or circular holes cut out of the rear side of the column base 170 to allow access to electronic connectors which are mounted on a printed circuit board assembly 295, which is mounted inside the column base, with the connectors facing the rear of the assembly 295. These connectors include but may not be limited to USB connectors, DC-in connectors, and/or HDMI connectors. It is understood that the electronic connectors may be mounted in many different locations on the column base 170, the column 115, or the projector housing.

In the present example, a carry handle 120 is made of plastic, metal, and/or another suitable material, and is attached to the base 300 of the screen assembly 125 via screws, glue, welds, and/or another appropriate fastening method. Although in the present embodiment, the carry handle 120 has a rectangular cross section, it is understood that the cross-sectional configuration may vary greatly.

In the present example, a screen assembly 125 comprises a touch-enabled projection screen 135, a screen frame 130, a projection screen base 300, and several foot pads 265. The touch-enabled projection screen 135 is substantially rectangular in shape and sits inside a depression in the projection screen base 300, which is also substantially rectangular in shape, with larger overall rectangular dimensions than the touch enabled projection screen 135. The depression formed in the projection screen base 300 has rectangular dimensions slightly larger than the touch-enabled projection screen 135, allowing the touch enabled projection screen 135 to fit snugly within the depression formed in the projection screen base 300.

The touch-enabled projection screen 135 may be fastened to the projection screen base 300 with screws, double-sided tape, glue, and/or any other appropriate fastening method. A screen frame 130 is attached to the top of the assembled touch-enabled projection screen 135 and projection screen base 300 with screws and/or any other appropriate fastening method, providing an aesthetically pleasing assembly and adding rigidity to the screen assembly 125.

Foot pads 265 may be attached to the bottom of the projection screen base 300 in various locations to provide a firm, non-slip footing on most relatively flat surfaces upon which the screen assembly 125 may sit.

In the present example, the touch-enabled projection screen 135 may be made by laminating a projected capacitive touch sensor array onto a fairly rigid sheet of acrylic or any other appropriate material. A sheet of vinyl or other opaque white or light-colored material may be laminated on top of the touch sensor array, forming an operable touch screen within a projection screen. For the purposes of an embodiment of an interactive projection display apparatus, it is understood that the means and methods to provide a touch-enabled screen may vary greatly. For example, many technologies exist which may be used, including but not limited to projected capacitive touch, surface acoustic wave, infrared, five-wire resistive, and/or projected infrared technologies may be used.

In the present example, the projection screen base 300 may be made of plastic, metal, or any other appropriate material or combination of materials. Features such as ridges, troughs, depressions or protrusions may be formed or cut into the base 300, in various orientations, to add structural rigidity and stiffness to the base 300.

In the present example, the screen frame 130 may be made of plastic, metal, or any other appropriate material or combination of materials. The frame 130 overlaps the gap between the touch-enabled projection screen 135 and the projection screen base 300, and wraps around the base 300 edges.

In the present example, the foot pads 265 may be made of a rubber, urethane, or any other appropriate material. The foot pads 265 may be formed by die cutting, injection molding, or any other appropriate method of manufacture. The foot pads may be attached to the projection screen base 300 with tape, glue, screws, or any other appropriate fastening method.

Referring to FIG. 9A, a cutaway view of one embodiment of the apparatus 100 of FIG. 1A, taken along lines A-A of FIG. 7E, is illustrated. In the present embodiment, the apparatus 100 may not have any substantial computer components, and acts as an interactive peripheral display to outside devices. Wired connections may be made with outside cables 250 and 255 which connect to inner cables 310 routed through the column base 170, the column 115, and the pivot mount 110 and into the projector housing 105, where a connection may be made to the projector components 290. Wireless connections to external computer devices may also be made.

Referring to FIG. 9B, a cutaway view of one embodiment of the apparatus 100 of FIG. 1A, taken along lines A-A of FIG. 7E, is illustrated. In the present embodiment, the apparatus 100 may contain substantial computer components including but not limited to a power supply 320, I/O circuitry 325, memory 330, a CPU 335, display circuitry 340, and communications circuitry 345. It is understood that the illustrations of these components are merely representations and do not imply any particular form factor, orientation, or size. In the present embodiment, the apparatus 100 may operate as an all-in-one computer and interactive display, independently or in conjunction with external computer devices via wire 250 or wireless connections.

It will be appreciated by those skilled in the art having the benefit of this disclosure that this table-top interactive projection display apparatus is portable, provides for viewing full size drawings at a 1:1 scale, and is easily updated and maintained. It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus, it is intended that the following claims be interpreted to embrace all such further modifications, changes, rearrangements, substitutions, alternatives, design choices, and embodiments.

What is claimed is:

1. A portable interactive projection display apparatus comprising:
a projector;
a touch-enabled projection screen;
a projector housing;
a projector mount;
a column assembly having a top end and a bottom end;
a column base; and
a holder for the touch-enabled projection screen;
wherein the projector is inside the projector housing, which is attached to the projector mount, which is attached to the top end of the column assembly, which is attached at the bottom end to a column base, which is attached to the holder for the touch-enabled projection screen, which holds the touch-enabled projection screen, such that, when assembled, the projector is arranged above and is pointing at the touch-enabled projection screen;
whereby is provided a portable interactive projection display which can be operated on a table top, plan table, desk top, or any substantially flat horizontal surface.

2. The portable interactive projection display apparatus of claim 1 further comprising multiple foot pads attached to the bottom of the holder for the touch-enabled projection screen whereby the holder can resist sliding on a relatively flat surface.

3. The portable interactive projection display apparatus of claim 1 further comprising a frame, wherein the frame covers the perimeter of the touch-enabled projection screen and the holder for the touch-enabled projection screen.

4. The portable interactive projection display apparatus of claim 1 further comprising a carry handle wherein the carry handle is attached to the holder for the touch-enabled projection screen.

5. The portable interactive projection display apparatus of claim 1 wherein the column assembly can collapse to a shorter height by means of a telescoping action.

6. The portable interactive projection display apparatus of claim 1 further comprising at least one control feature positioned on an exterior side of the projector housing, wherein the at least one control feature is coupled to the processor.

7. The portable interactive projection display apparatus of claim 1 further comprising a wireless connection to external devices, whereby information and images produced from said external devices can be displayed on and controlled via the touch-enabled projector screen.

8. The portable interactive projection display apparatus of claim 1 further comprising a switch, wherein the switch is connected via wire to the touch-enabled projection screen, whereby touch sensors contained within the touch-enabled projection screen can be disabled and re-enabled by means of operating the switch.

9. The portable interactive projection display apparatus of claim 1 wherein the touch-enabled projection screen is set at an angle to a surface upon which the apparatus sits, whereby easier use and viewability can be achieved.

10. The portable interactive projection display apparatus of claim 1 further comprising a hinge assembly and a latch assembly wherein the column assembly is attached to the column base via said hinge and latch assemblies, whereby the column can fold down toward the touch-enabled projection screen.

11. The portable interactive projection display apparatus of claim 10 wherein the column assembly has multiple sections and is joined together by means of hinges and latches, whereby the column assembly can collapse into several smaller sections.

12. The portable interactive projection display apparatus of claim 1 wherein the column assembly is substantially hollow.

13. The portable interactive projection display apparatus of claim 12 wherein the column assembly contains wires which are routed from the projector, through the projector housing, through the projector mount, through the column assembly, through openings at the bottom end of the column assembly, whereby connections can be made to external devices.

14. The portable interactive projection display apparatus of claim 13 wherein the column base is substantially hollow and said wires are routed through openings in the column base.

15. The portable interactive projection display apparatus of claim 14 wherein a plurality of electronic components are positioned inside the column assembly, wherein the electronic components are operable to generate signals to control and/or power the projector and the touch-enabled projection screen and wherein the plurality of electronic components comprise a processor coupled to the touch-enabled projector screen, a memory coupled to the processor, display circuitry coupled to the processor and the projector, and a power supply coupled to the processor, the memory, the touch-enabled projector screen, and the projector.

16. The portable interactive projection display apparatus of claim 14 further comprising a circuit board assembly in the column base, wherein the circuit board assembly serves as a hub for wired connections.

17. The portable interactive projection display apparatus of claim I wherein the projector mount can pivot, whereby the projector can be arranged to point in many different directions about a pivot axis.

18. The portable interactive projection display apparatus of claim 17 further comprising ball detents features inside the pivoting projector mount whereby automatic stopping points about the pivot axis are provided.

19. The portable interactive projection display apparatus of claim 17 further comprising an axial clamp assembly which is attached to the pivoting projector mount along the pivot axis, whereby a manual adjustment to the angle of the projector housing about the pivot axis is provided.
